(19) United States
(12) Patent Application Publication
(10) Pub. No.: US 2016/0065013 A1
(43) Pub. Date: Mar. 3, 2016

(54) MAGNET ARRANGEMENT FOR CLAW-POLE ELECTRIC MACHINE

(71) Applicant: Remy Technologies LLC, Pendleton, IN (US)

(72) Inventor: Jiwon Chung, Fishers, IN (US)

(21) Appl. No.: 14/473,698

(22) Filed: Aug. 29, 2014

(51) Int. Cl. H02K 1/22; H02K 1/28

(52) U.S. Cl. CPC H02K 1/226; H02K 1/28

(57) ABSTRACT

An electric machine comprises a stator and a rotor configured to rotate about an axis of rotation in a direction of angular rotation. The rotor includes a first claw-pole segment and an opposing second claw-pole segment. The first claw-pole segment includes a plurality of first fingers extending from a first end member with an opening between each of the plurality of first fingers. The second claw-pole segment includes a plurality of second fingers extending from a second end member with an opening between each of the plurality of second fingers. A plurality of magnets are positioned on the rotor, each of the plurality of magnets positioned between a pair of first and second fingers. A molded plastic insert is positioned on the rotor, the molded plastic insert positioned in one of the openings and extending over an outer surface of each of the plurality of magnets.

### FIELD

This application relates to the field of electric machines, and particularly to permanent magnet arrangements in electric machines having claw-pole rotors.

### BACKGROUND

Alternators with claw-pole rotor arrangements (also known as “Lundell” type rotors) are commonly used in light-duty and heavy-duty vehicle applications. These alternators include a claw-pole rotor, a stator, a rectifier and a voltage regulator. The rotor is comprised of a field coil wound over an iron core and two opposing claw-pole iron segments surrounding the field coil. Each claw-pole iron segment typically includes six to nine fingers that are interlaced with the same number of fingers from the opposing claw-pole iron segment. When current flows through the field winding, one of the claw-pole segments provides a magnetic north segment and the other provides a magnetic south segment. Thus, the interlaced fingers of the claw-pole configuration result in a rotor with an alternating N pole/S pole arrangement.

In many alternators, permanent magnets are also included between the claw-pole segments, further defining the N pole/S pole arrangement. An example of such an alternator with permanent magnets is provided in U.S. Pat. No. 5,747,913. The permanent magnets are typically installed and retained on the rotor by slot machining the claws and sliding the magnets into the slots. Additional parts in the form of retainers are then used to lock the magnets in place. The process of machining the claw-poles, inserting the magnets, and adding the retainers is relatively complex and labor intensive, resulting in significant additional cost to the production of claw-pole rotor arrangements having permanent magnets.

In addition to the above, the outer diameter of a claw-pole rotor is often machined following assembly of the rotor in order to balance the rotor during operation. The machining processes, which occur both before and after magnet insertion into the rotor, results in numerous ferro-magnetic chips that may be attracted by the magnets positioned between the claw-poles. For this reason, the magnets of many claw-pole rotors are inserted between the claw-poles in an unmagnetized condition. Thereafter, following the balancing process, the magnetic chips are blown, vacuumed or otherwise moved away, and the magnets are then magnetized. However, magnetization of the magnets after insertion into the claw-pole rotors requires additional time and expense, thus adding to the manufacturing cost of the rotor.

During operation of an electric machine having a claw-pole rotor with magnets included thereon, rotation of the rotor provides a rotating magnetic field. This rotating magnetic field induces a voltage in the windings positioned on the stator. The magnetic field in the stator rotates at the same speed, or synchronously, with the rotor field. The stator windings are connected to the rectifier, which converts the AC stator output to a DC output. At the same time, the voltage regulator monitors the system voltage and adjusts the output of the alternator by controlling the current through the field coil. The permanent magnets on the rotor generally increase the alternator output and efficiency, especially at lower engine operating speeds.

In view of the foregoing, it would be desirable to provide an alternator arrangement having a claw-pole rotor with an improved permanent magnet arrangement. It would be desirable if such claw-pole rotor with an improved permanent magnet arrangement were relatively easy to manufacture, requiring fewer parts and less labor. It would also be desirable if such a claw-pole rotor with improved permanent magnet arrangement performed comparable to more expensive claw-pole rotor arrangements.

### SUMMARY

An electric machine comprises a stator and a rotor configured to rotate about an axis of rotation in a direction of angular rotation. The rotor includes a first claw-pole segment and an opposing second claw-pole segment. The first claw-pole segment includes a plurality of first fingers extending from a first end member with an opening between each of the plurality of first fingers. The second claw-pole segment includes a plurality of second fingers extending from a second end member with an opening between each of the plurality of second fingers. A plurality of magnets are positioned on the rotor, each of the plurality of magnets being positioned between a pair of first and second fingers. A molded plastic insert is positioned on the rotor, the molded plastic insert positioned in at least one of the openings and extending over an outer surface of one of the plurality of magnets.

In accordance with one embodiment of the disclosure, there is provided a rotor for an electric machine. The rotor comprises a first segment including a first plurality of fingers extending in a first axial direction and a second segment including a second plurality of fingers extending in a second axial direction opposite the first axial direction. The second fingers are interleaved with the first fingers and slots extend between the first and second fingers. Magnets are positioned in the slots between the first fingers and the second fingers. A plastic insert is overmolded on the magnets.

Pursuant to yet another embodiment of the disclosure, there is provided a rotor for an electric machine comprising a first claw-pole segment including a plurality of first fingers extending from a first end member at a knuckle. The first end member includes a plurality of recesses, each of the plurality of recesses formed in the first end member between a pair of knuckles. A second claw-pole segment includes a plurality of second fingers extending from a second end member. Each of the plurality of second fingers extends from the second end member at a knuckle and extends between a pair of first fingers, the second end member further including a plurality of recesses, each of the plurality of recesses formed in the second end member between a pair of knuckles. A plastic insert is positioned in the plurality of recesses of the first end member and the second end member. A plurality of magnets are at least partially covered the plastic insert.

The above described features and advantages, as well as others, will become more readily apparent to those of ordinary skill in the art by reference to the following detailed description and accompanying drawings. While it would be desirable to provide an alternator arrangement that provides one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

FIG. 1 shows a cross-sectional view of an electric machine including a claw-pole rotor;

FIG. 2 shows a side view of a claw-pole rotor with a permanent magnet arrangement for use in the electric machine of FIG. 1;

FIG. 3 shows a perspective view of the claw-pole rotor of FIG. 2;

FIG. 4 shows a cross-sectional view along line IV-IV of FIG. 2 showing permanent magnets positioned between fingers of the claw-pole rotor; and

FIG. 5 shows a cross-sectional view along line V-V of FIG. 2 showing a molded plastic insert within the claw-pole rotor.

### DESCRIPTION

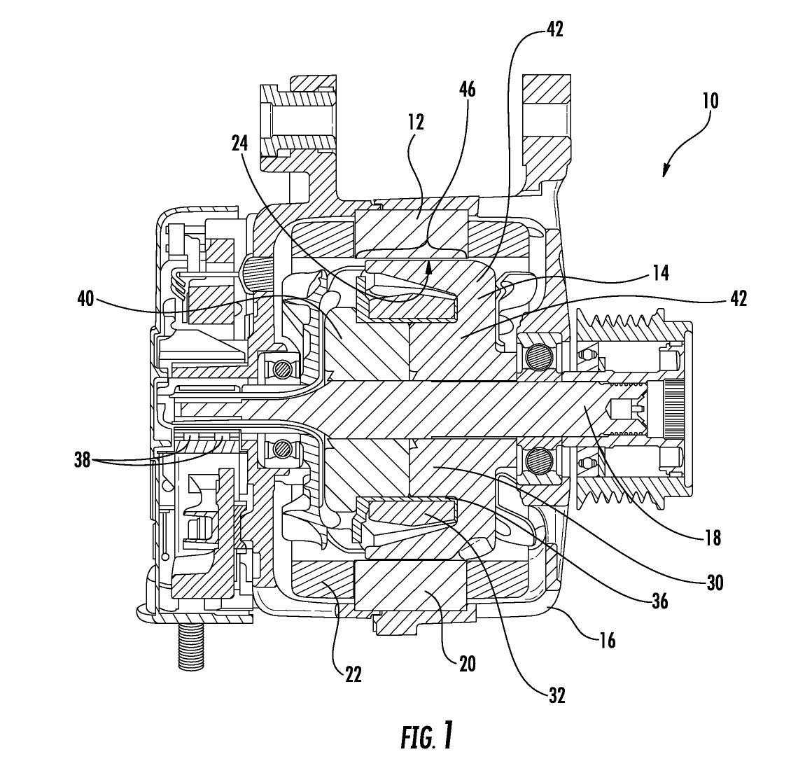

With reference to FIG. 1, an electric machine is shown in the form of a claw-pole alternator 10. The alternator includes a stator 12 and a claw-pole rotor 14 positioned within a housing 16. The rotor 14 is connected to a shaft 18. As is well known in the art, the shaft 18 may be driven by a belt (not shown) during operation of the vehicle in which the alternator is mounted.

The stator 12 is stationary within the alternator housing 16. The stator 12 includes a stator core 20 and stator windings 22. The stator core 20 includes a plurality of teeth that extend radially inward from the outer diameter of the stator core. The stator windings 22 are retained by slots formed between the teeth of the stator core. The stator windings 22 may be formed by insulated copper wires that form coils that wrap around the stator core. The coils are separated into three distinct winding segments that provide a three-phase electrical output for the alternator 10.

The rotor 14 is rotatably positioned inside of the stator 12 within the alternator. The rotor 14 is separated from the stator 12 by an airgap 24 in an active airgap region 46 of the rotor. The rotor 14 includes an iron core 30, a field coil 34, and two claw-pole segments 40, 42. The iron core 30 may be provided by one or more of the claw-pole segments 40, 42. In the disclosed embodiment, the field coil 34 is wound around an iron spool 36, and the field coil 34 and spool 36 rotate with the rotor within the alternator housing 16. Accordingly, the rotor is a brush-type rotor and a plurality of brushes 38 deliver electrical current to the rotor via the brushes. The first claw-pole segment 40 extends radially outward from the spool 36. The first claw-pole segment 40 may be connected to the second claw-pole segment 42 by a connection ring 44. Alternatively, the first claw-pole segment 40 and the second claw-pole segment 42 may both be secured to the shaft 18. The rotor core 30 is also secured to the second claw-pole segment 42 and the shaft 18. Accordingly, the iron core 30, the first claw-pole segment 40 and the second claw-pole segment 42 are all rotatable along with the shaft 18 within the alternator housing 16.

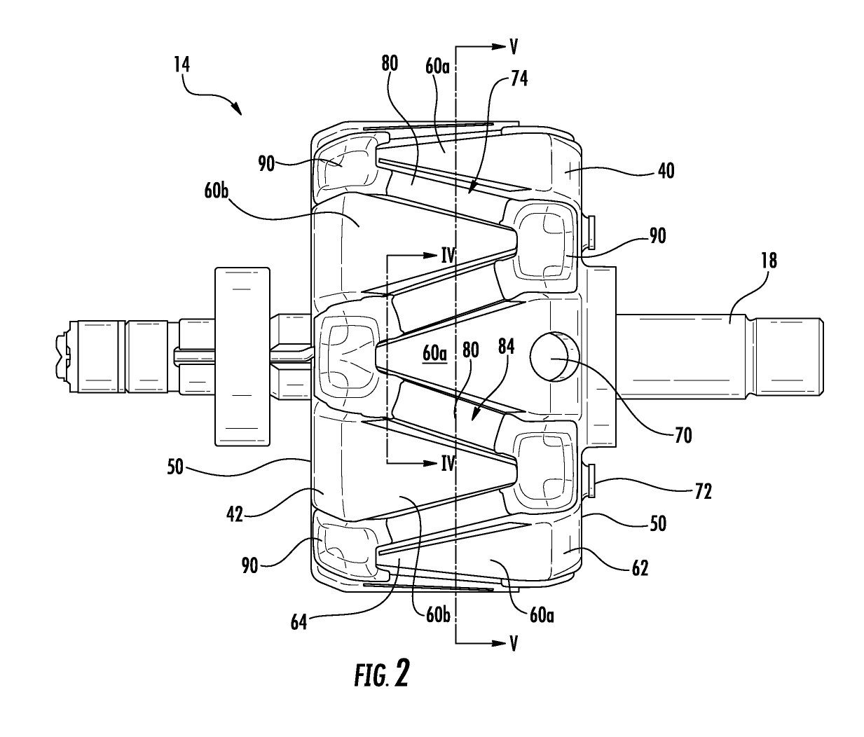

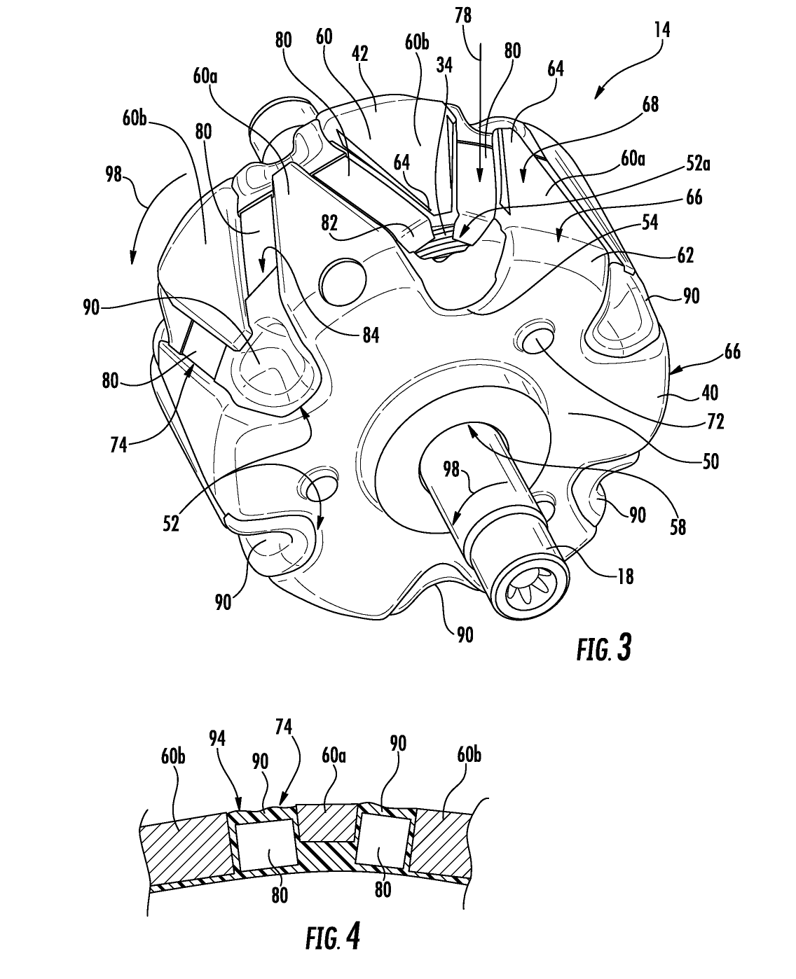

FIGS. 2 and 3 show the first and second claw pole segments 40, 42 isolated from the remaining portions of the rotor 14. The first claw pole segment 40 is includes a generally flat end member in the form of an end plate 50. The end plate 50 has a generally circular outer perimeter with a plurality of recesses 52 formed therein. As a result, the end plate 50 may also be considered to be star or gear shaped. The circular end plate 50 is connected to the shaft 18 and rotates therewith. A hole 58 is provided at the center of the end plate 50 through which the shaft 18 passes.

A plurality of fingers 60 extend from the end plate 50 with knuckle portions 62 positioned on the fingers 60. In the embodiment of FIG. 2, the knuckle portions 62 are provided at the perimeter of the endplate 50 and are generally enlarged relative to the tip portions 64 of each finger 60. In FIG. 2, the knuckles 62 provide a surface 66 that forms a substantially 90° turn on each finger 60. The recesses 52 are formed in the end plate 50 between the knuckles 62. The recesses 52 are defined within U-shaped surfaces 54 that extend between the knuckles 62.

Each finger 60 of the open segment 40 includes an exterior side 68 that faces the stator 12, an interior side (not shown in FIGS. 2 and 3) that faces the field winding 34, a distal end provided by the tip portion 64 of the finger (i.e., the distal end is furthest from the end plate 50), and a proximal end provided at the knuckle portion 62 (i.e., the proximal end of the finger that is connected to the end plate 50). Each finger 60 also includes a leading side/edge and a trailing side/edge, with the leading edge and trailing edge of each finger defined by a direction of angular rotation of the rotor, as noted by arrow 98. Each finger 60 is generally triangular in shape when viewed from the exterior side, and is tapered toward the tip portion 64, the diameter of the tip portion 64 being less than the diameter of the knuckle portion 62.

As noted previously, U-shaped surfaces 54 are provided on the end plate 50 and generally extend between adjacent fingers 60 on the on the first claw pole segment 40 near the knuckle portions 62. Because these U-shaped surfaces 54 extend between adjacent fingers 60, they may also be referred to herein as “web portions”. The web portions 54 provide a smooth curved surface extending between adjacent fingers 60.

One or more cavities 56 may also be formed in the end plate 50 or on the fingers 60 of the claw pole segment 40. These cavities 56 are generally pre-formed holes, machined bores or depressions that are formed in the end plate 50 or fingers 60 in order to balance claw pole segment 40 resulting in smooth rotation of the claw pole segment 40. Similarly, a plurality of protuberances 72 may also be formed in the end plate 50. These protuberances 72 help balance the claw-pole segment 40 and may be machined, if necessary, to further balance the claw-pole segment 40.

The second segment 42 is substantially identical to the first segment 40. Accordingly, the same reference numerals are used herein to refer to the components of both the first segment 40 and the second segment 42. However, as shown in FIGS. 2 and 3, the fingers 60 of the first segment 40 may be specifically identified by reference numeral 60a, and the fingers of the second segment 42 are specifically identified by reference numeral 60b.

As shown in FIGS. 2 and 3, the fingers 60b of the second segment 42 are interlaced with fingers 60a from the opposing first segment 40. In particular, the fingers 60b of the second segment 42 extend toward the first segment 40 and into gaps between the fingers 60a of the first segment 40. Likewise, the fingers 60a of the first segment 40 extend toward the second segment 42 and into gaps between the fingers 60b of the second segment 42. As a result, the fingers 60a, 60b alternate around the center of the rotor 14. Because the fingers 60a and 60b define poles for the rotor 14, fingers 60a and 60b may also be referred to herein as rotor “poles”.

Slots 74 are formed between each of the fingers 60a of the first segment 40 and each of the fingers 60b of the second segment. The tapered shape of the fingers 60a and 60b arranged in alternating directions results in the sides of the slots 74 being substantially parallel. Alternating slots 74 are offset from the axial direction (defined by the shaft 18) by about 10° to about 30°.

Permanent magnets 80 are positioned in each of the slots 74. The permanent magnets are generally box shaped (i.e., rectangular parallelepiped shaped) with the cross-section of each permanent magnet 80 being a rectangle. Each magnet 80 is oriented in the same direction in each slot 74 with one pole (e.g., the south end) of the magnet near the knuckle portion 62 of the finger 60 and the opposite pole (e.g., the north end) of the magnet 80 near the tip portion 64 of the finger 60. The width of each magnet 80 is less than the width of the slot 74. This allows each magnet 80 to be inserted into the slot 74 in a radial direction, as indicated by arrow 78 in FIG. 3. An exterior surface 84 of each magnet is exposed in the slot 74.

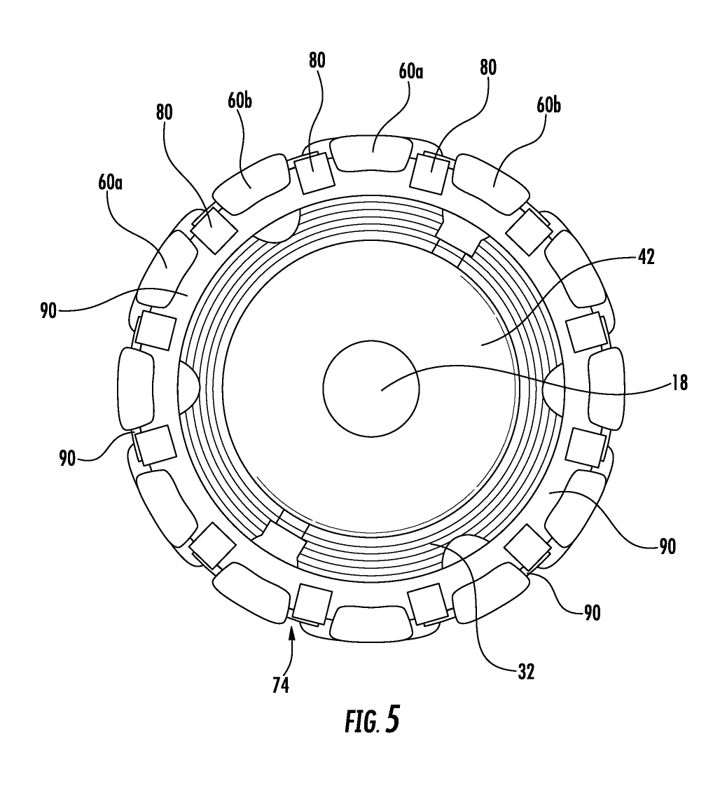

With continued reference to FIGS. 2 and 3, the recess 52 between each knuckle portion 62 is filled with a plastic material in the form of a molded plastic insert 90. The molded plastic insert 90 substantially fills the recess 52 between each knuckle portion, covering the axial end of the tip portion 64 of the finger 60 which extends into the recess 52. Additionally, as shown in FIGS. 4 and 5, the molded plastic insert 90 also extends across the complete underside of each magnet 80 in each slot 74. Accordingly, the molded plastic insert 90 substantially or completely covers the coil 32 such that no actual air gap is provided between the coil 32 and the claw-pole segments 40, 42. Thus, the molded plastic insert 90 in the embodiment of FIGS. 2-5 is one unitary and continuous component that extends into each recess 52 and slot 74 of the rotor 14. It will be recognized that in other embodiments, the molded plastic insert may be split into a number of different components.

The molded plastic insert 90 may be comprised of any of a number of resilient materials having good thermal conductivity and a high melting point, including various polymers such as polycarbonate, high density polyethylene, polypropylene, or any of various other polymers as will be recognized by those of ordinary skill in the art as being appropriate for use in the rotor 14. In at least some embodiments, the selected polymer may be injected with metals or ceramics to increase thermal conductivity or other properties of the polymer. The material used for the molded plastic insert is a material that may be insert injection molded into various cavities of the rotor 14.

FIG. 3 shows a perspective view of the rotor 14 with a cutaway of the molded plastic insert 90 in one of the recesses 52a of the first claw-pole segment 40. The recess 52a is shown with the associated molded plastic insert substantially removed from view, thus exposing the axial ends 82 of the magnet 80 and the tip portion 64 of the finger 60b. When the molded plastic insert 90 is positioned in this recess 52a, the molded plastic insert 90 covers the axial end of the tip portion 64 of the finger 60b, the axial end 82 of the magnets 80 to the left and right of the finger 60b, and a portion of the exterior surfaces 84 of the two magnets 80 to the left and right of the finger 60.

As shown in FIG. 4, the molded plastic insert 90 forms part of an outer surface 94 on the rotor 14 that covers the exterior surface 84 of the magnets 80 without covering the exterior surface of the fingers 60. In this embodiment, the molded plastic insert 90 provides a bridge between the fingers, the outer diameter of the rotor being substantially the same at the outer surface 94 of the molded plastic insert 90 and at the outer surface of the exterior side 68 of the finger 60. Also, as shown in FIGS. 4 and 5, the molded plastic insert 90 fills any gaps between the fingers 60 and the magnets 80 within the slots 74. Additionally, the molded plastic insert 90 fills the space between the coil 32 and the inner surfaces of the magnets 80 and claw-pole segments 40-42. The molded plastic insert 90 is therefore secured to the rotor segments 40, 42, extending between the end plates 50 of the opposing claw pole segments. As a result, the molded plastic insert 90 secures the magnets 80 in place within the recesses 52 and slots 74 between the segments 40, 42.

As best shown in FIGS. 2 and 3, the molded plastic insert 90 extends over a sufficient portion of the exterior surface 84 of the magnet to lock the magnet 80 in place and prevent it from escaping the rotor 14 when high centrifugal forces are experienced by the rotor and magnets during operation of the electric machine. In at least one embodiment, as shown in FIGS. 2 and 3, the material of the molded plastic insert 90 extends over at least 10% of the outer surface 84 of the one of the plurality of magnets 80. In at least one embodiment, the outer surface 84 of each of the plurality of magnets 80 is at least 50% covered by the molded plastic insert 90.

In order to manufacture the rotor arrangement 14, the opposing claw pole segments 40 and 42 are positioned on the shaft 18. When the opposing claw pole segments 40 and 42 are properly positioned, the opposing fingers 60a and 60b are interlaced such that the slots 74 are formed between the fingers 60. The permanent magnets 80 are then aligned with the slots 74 and inserted into the slots 74 in a radial direction, as noted by arrow 78 of FIG. 3. Advantageously, because no machining of the rotor segments 40, 42 is required to insert the magnets 80 into the slots 74, the magnets may be pre-magnetized. Thus, no additional magnetization step is required for the magnets. After the permanent magnets are inserted into the slots, a molding process occurs wherein the molded plastic insert 90 is insert molded (which insert molding may also be referred to as injection molding) in the recesses 52, slots 74, and cavities between the coil 32 and the inner surfaces of the magnets 80 and rotor segments 40, 42. As a result, the voids in the recesses 52, slots 74 and other locations within the segments 40, 42 are filled with the molded plastic insert 90. Accordingly, the molded plastic insert 90 retains the magnets in place within the slots. The molded plastic insert 90 engages one magnet 80 on the left side of each recess 52 and another magnet 80 on the right side of the recess 52. The permanent magnets 80 may be held in place during the molding process using any of various means such as a robotic arm that grasps one end of the magnet 80 while the other end is insert molded. Alternatively, the magnet may be retained near a central portion during the insert molding process using any of various means including a retainer positioned in the recess 52 or slot 74, a groove formed in the recess or slot, a magnetized arm, or any of various other means. Accordingly, it will be recognized that in at least one embodiment of the molding process described herein, the plastic material that forms the insert 90 is inserted into the structure only after all other rotor components are assembled. In this embodiment, the plastic insert 90 substantially fills all of the gaps of the rotor assembly (specifically those gaps between the rotor coil 32 and the exterior surface of the rotor segments 40,42). Advantageously, the plastic insert 90 holds the magnets in place in the slots 74 following complete assembly of the rotor.

General operation of the alternator 10 is now described with reference again to FIG. 1. When current flows through the field coil 34, it produces a magnetic field with an N pole at one end of the field coil and an S pole at the opposite end of the field coil. The two claw pole segments 40, 42 of the rotor 14 channel the magnetic flux produced from the field coil 34 to the appropriate surface on the stator 12. The useful flux linkage between the stator 12 and the rotor 14 is in the form of a closed loop that travels through the stator 12, the claw-pole segments 40, 42, the spool 36, the rotor core 32, and any gaps between such components.

The DC current in the field winding 34 induces a magnetic N in one claw-pole segment 40 and a magnetic south in the other claw-pole segment 42. Because the fingers of the claw pole segments are interlaced, this result in an alternating N pole, S pole arrangement. The permanent magnets 80 positioned in the slots 74 of the rotor further strengthen the magnetic field through the claw-pole segments 40, 42. Since the claw-pole segments 40, 42 are attached to the rotating alternator shaft 18, the magnetic field experienced by the stator 12 at any fixed point alternates between N and S in a cyclical or AC fashion. This rotating magnetic field induces a voltage in the stator windings. The stator windings are connected to a diode rectifier that converts the AC stator output to a DC output that is used to charge the battery and power vehicle loads. A voltage regulator monitors the system voltage and adjusts the output of the alternator by controlling the current through the field coil.

The foregoing detailed description of one or more embodiments of the permanent magnet arrangement for claw-pole electric machines has been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by the appended claims. Therefore, the spirit and scope of any appended claims should not be limited to the description of the embodiments contained herein.

What is claimed is:

1. An electric machine comprising:
a stator;
a rotor configured to rotate about an axis of rotation in a direction of angular rotation, the rotor including a first claw-pole segment and an opposing second claw-pole segment, the first claw-pole segment including a plurality of first fingers extending from a first end member with an opening between each of the plurality of first fingers, and the second claw-pole segment including a plurality of second fingers extending from a second end member with an opening between each of the plurality of second fingers;
a plurality of magnets positioned on the rotor, each of the plurality of magnets positioned between a pair of first and second fingers; and
a molded plastic insert positioned on the rotor, the molded plastic insert extending into one of the openings and extending over an outer surface of at least one of the plurality of magnets.

2. The electric machine of claim 1 wherein the molded plastic insert extends over at least 10% of the outer surface of the one of the plurality of magnets.

3. The electric machine of claim 2 wherein the outer surface of each of the plurality of magnets is at least 50% covered by the molded plastic insert.

4. The electric machine of claim 1 wherein the pair of first and second fingers plurality of magnets do not engage grooves in the fingers.

5. The electric machine of claim 1 wherein the molded plastic insert extends from the first end member to the second end member.

6. The electric machine of claim 1 wherein the molded plastic insert extends between a first finger and a second finger.

7. The electric machine of claim 1 wherein the molded plastic insert is comprised of a thermoplastic material.

8. The electric machine of claim 1 wherein the first end member is a ferro-magnetic plate.

9. The electric machine of claim 8 wherein the ferro-magnetic plate is fixedly connected to an axle.

10. A rotor for an electric machine comprising:
a first segment including a first plurality of fingers extending in a first axial direction;
a second segment including a second plurality of fingers extending in a second axial direction opposite the first axial direction, the second fingers interleaved with the first fingers with slots extending between the first and second fingers;
magnets positioned in the slots between the first fingers and the second fingers; and
a molded insert overmolded on the magnets.

11. The rotor of claim 10 wherein the first plurality of fingers extend from a first end plate and the second plurality of fingers extend from a second end plate.

12. The rotor of claim 11 wherein the first end plate includes a plurality of recesses formed between the first plurality of fingers, and the second end plate includes a second plurality of recesses formed between the second plurality of fingers.

13. The rotor of claim 12 wherein the molded insert is positioned in the plurality of recesses of the first end plate and the second end plate.

14. The rotor of claim 10 wherein the molded insert extends over at least 10% of an outer surface of the one of the magnets.

15. The electric machine of claim 14 wherein the outer surface of each of the magnets is at least 50% covered by the molded insert.

16. The electric machine of claim 10 wherein the magnets are dimensioned for insertion in a radial direction in the slots.

17. The electric machine of claim 10 wherein the molded insert is comprised of a plastic material.

18. The electric machine of claim 10 wherein the first plurality of fingers extend from a first plate that is fixedly connected to an axle and wherein the second plurality of fingers extend from a second plate that is fixedly connected to the axle.

19. A rotor for an electric machine comprising:
a first claw-pole segment including a plurality of first fingers extending from a first end member, each of the plurality of first fingers extending from the first end member at a knuckle, the first end member including a plurality of recesses, each of the plurality of recesses formed in the first end member between a pair of knuckles;
a second claw-pole segment including a plurality of second fingers extending from a second end member, each of the plurality of second fingers extending from the second end member at a knuckle and extending between a pair of first fingers, the second end member further including a plurality of recesses, each of the plurality of recesses formed in the second end member between a pair of knuckles;
a plastic insert positioned in at least one of the plurality of recesses of the first end member and the second end member; and
a plurality of magnets at least partially covered by the plastic insert.
